(19) United States
(12) Patent Application Publication
(10) Pub. No.: US 2026/0226340 A1
(43) Pub. Date: Aug. 6, 2026

(54) Antiscalant Compositions and Methods of Use

(71) Applicant: Locus Solutions IPCo, LLC, Solon, OH (US)

(72) Inventors: Gabriela KNESEL, Solon, OH (US); Ronney SILVA, Solon, OH (US); Cathrine MONYAKE, Solon, OH (US); Juan CERVANTES, Solon, OH (US); Megan R. PEARL, Solon, OH (US)

(21) Appl. No.: 18/839,549

(22) PCT Filed: Feb. 14, 2024
(86) PCT No.: PCT/US2024/015673

§ 371 Date: Aug. 19, 2024

Related U.S. Application Data
(60) Provisional application No. 63/485,289, filed on Feb. 16, 2023.
(60) Provisional application No. 63/583,632, filed on Sep. 19, 2023.

(51) Int. Cl. C09K 8/528; C02F 1/66; C02F 3/34; C02F 5/10; C02F 103/00; C02F 103/06; C02F 103/10; C22B 1/11

(52) U.S. Cl. CPC C09K 8/528; C02F 1/66; C02F 3/347; C02F 5/10; C22B 1/11; C02F 2103/001; C02F 2103/06; C02F 2103/10; C02F 2209/02; C02F 2209/03; C02F 2209/055; C02F 2209/06

(57) ABSTRACT

The subject invention provides safe, environmentally-friendly compositions and efficient methods for inhibiting scale formation or removing scale. More specifically, the subject invention provides compositions derived from microorganisms for inhibiting scale formation or removing scale, particularly from surface used in various industrial processes.

### CROSS-REFERENCE TO RELATED APPLICATIONS

This application claims priority to U.S. Provisional Patent Application Nos. 63/485,289, filed Feb. 16, 2023, and 63/583,632, filed Sep. 19, 2023, each of which is incorporated herein by reference in its entirety.

### BACKGROUND OF THE INVENTION

Mining or excavating of rock, including quarrying, and the processing of the resulting materials can use water containing a variety of minerals. In the processing of mined materials, mineral scale can inhibit the efficiency of operations. For example, heating and/or cooling of liquids containing the minerals can allow for scale to form on equipment, pipes, tubing, pumps, and drains. This scale can inhibit the flow of liquid, force the shutdown of operations to allow for cleaning, and reduce the lifespan of equipment. The most common mineral scalants include, for example, calcium carbonate, calcium sulfate, strontium sulfate, barium sulfate, calcium phosphate, calcium fluoride, and magnesium silicate.

Antiscalants are a family of chemicals designed to inhibit the accumulation of crystallized minerals that form scale. Common antiscalants are organic synthetic polymers (e.g., polyacrylic acids, carboxylic acids, polymaleic acids, organophosphates, polyphosphates, phosphonates, and anionic polymers). These synthetic polymers can prevent initial scale by inhibiting mineral attachment on equipment surfaces. To slow and minimize scale formation, the synthetic antiscalants can modify the surfaces of existing mineral crystals so that new layers of scale do not form. For any scale that does form, the antiscalants disrupt the structure of the scale, making it easier to remove.

In addition to the use of antiscalants in the mining industry, an antiscalant is used in a variety of industries that use liquids containing minerals, such as, for example, paper making, beer brewing production, and for water treatment.

Novel, improved antiscalant compositions and methods are needed.

### BRIEF SUMMARY OF THE INVENTION

The subject invention relates generally to antiscalant compositions and methods of using these compositions. More specifically, the subject invention provides environmentally-friendly antiscalant compositions and methods for scale inhibition and the removal of scale, such as, for example, in methods of mining, oil and gas production, water treatment, and industrial production. In certain embodiments, existing methods can incorporate the subject compositions and methods.

Advantageously, the compositions and methods of the subject invention increase the efficiency of descaling or inhibiting scale formation and can decrease the chemical usage, including synthetic antiscalant polymer usage. Accordingly, the subject invention can be useful for reducing the time needed for mining, water treatment (e.g., mining wastewater or municipal water) or producing various products, including, for example, paper and beer.

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water, chemical surfactants, antiscalants, polymers, pH modifying agents, chelating agents, or any combination thereof.

In certain embodiments, the biosurfactant of the composition is utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin, and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically. In preferred embodiments, the SLP is a linear SLP or a derivatized linear SLP.

In certain embodiments, the subject invention provides a method for inhibiting scale formation or the removal of scale, wherein the method comprises the following step: contacting an antiscalant composition according to the subject invention to a liquid or to a surface.

Additionally, in preferred embodiments, the antiscalant composition can be used to enhance the performance, appearance and/or longevity of an object or surface to which the antiscalant composition is applied. For example, in some embodiments, application of an antiscalant composition according to the subject invention can enhance the longevity of the surface and/or object by preventing fouling by non-living substances.

In some embodiments, the method comprises contacting an antiscalant composition comprising a biosurfactant and, optionally, other components, such as, for example, water, chemical surfactants, polymers, antiscalants, pH modifying agents, chelating agents, or any combination thereof to a liquid containing minerals. In certain embodiments, the antiscalant composition can be applied to the liquid for a period of time and/or until a distinct volume of the composition has been applied. The step can be repeated as many times as necessary to achieve a desired removal of existing scale or decrease in the rate of the formation of scale.

In certain embodiments, the antiscalant composition, according to the subject invention, is effective due to the ability to maintain supersaturated solutions of soluble salts, altering the shape of scale crystals, and/or separating scale-forming crystals.

In certain embodiments, the methods of the subject invention result in at least a 25% reduction in the amount of scale on a surface, preferably at least a 50% decrease, after one treatment. In certain embodiments, the methods of the subject invention result in at least a 25% reduction in the rate of scale formation, preferably at least a 50% decrease, after one treatment. In certain embodiments, a liquid or surface can be treated multiple times to further decrease the amount of scale or rate of scale formation.

Advantageously, in certain embodiments, the antiscalant composition according to the subject invention can be effective at increasing the efficiency of industrial processes, particularly refining of metals and reverse osmosis water purification. Furthermore, the methods of the subject invention do not require complicated equipment or high energy consumption, and production of the composition can be performed on site, for example, at a mine or at a water treatment facility.

### DETAILED DESCRIPTION

The subject invention relates generally to a decrease in the amount of scale or rate of scale formation. More specifically, the subject invention provides environmentally-friendly compositions and methods for inhibiting scale formation or presence, such as, for example, in liquids or on surfaces that are used at mining sites, for water purification, and in industrial activities. Accordingly, the subject invention is useful for improving the efficiency and efficacy of methods of scale inhibition. Advantageously, the compositions and methods of the subject invention decrease the rate of scale formation or the amount of scale on a surface using safe, environmentally-friendly compositions.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally-derived substrates. 10 Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to reduce the surface tension also permits their use as antibacterial, antifungal, and hemolytic agents to, for example, control pests and/or microbial growth. Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

In certain embodiments, the biosurfactant is a sophorolipid (SLP). As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, SLP-salt derivatives (e.g., a sodium salt of a linear SLP), and other, including those that are and/or are not described within in this disclosure.

Sophorolipids are glycolipid biosurfactants produced by yeasts when cultivated in the presence of a hydrocarbon-based source of one or more fatty acids. Sophorolipid-producing yeasts can include Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi.

SLP typically consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-Δ9-octadecenoic acid. The hydroxy fatty acid is generally 16 or 18 carbon atoms, and may contain one or more unsaturated bonds. Furthermore, the sophorose residue can be acetylated on the 6- and/or 6′-position(s). The fatty acid carboxyl group can be free (acidic or linear form (General Formula 2)) or internally esterified at the 4″-position (lactonic form (General Formula 1)). S. bombicola produces a specific enzyme, called S. bombicola lactone esterase, which catalyzes the esterification of linear SLP to produce lactonic SLP.

In preferred embodiments, the SLP according to the subject invention are represented by General Formula (1) and/or General Formula (2), and include 30 or more structural homologs:

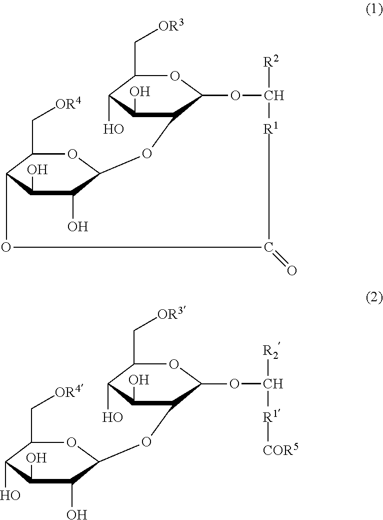

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃. R⁵ can be, e.g., —OH or an alcohol group.

The composition utilized according to the subject methods can comprises more than one form of SLP, including linear SLP and lactonic SLP. The SLP can be non-acetylated, mono-acetylated and/or di-acetylated SLP.

In certain specific embodiments, the composition comprises SLP according to General Formula (1) (linear SLP) wherein R¹ and/or R² are an acetyl group, and wherein R³ is derived from a stearic, oleic and/or linoleic fatty acid.

SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

In certain embodiments, the glycolipid is a rhamnolipid. Rhamnolipids comprise a glycosyl head group (i.e., a rhamnose) moiety, and a 3-(hydroxyalkanoyloxy)alkanoic acid (HAA) fatty acid tail, such as, e.g., 3-hydroxydecanoic acid. Two main subtypes of rhamnolipids exist, mono- and di-rhamnolipids, which comprise one or two rhamnose moieties, respectively. The HAA moiety can vary in length and degree of branching, depending on, for example, the growth medium and the environmental conditions. The highest accumulation of rhamnolipids (RLP) has been shown by submerged cultivation of Pseudomonas spp., such as P. aeruginosa.

Rhamnolipids according to the subject invention can have the following structure, according to General Formula (3):

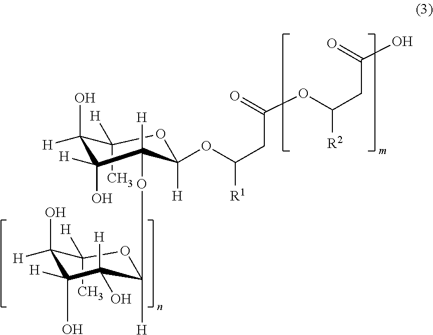

wherein m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated,
wherein the alkyl functional group is a linear saturated alkyl functional group having 8 to 12 carbon atoms, or is a nonyl or a decyl functional group or a mixture thereof.

Salts of these compounds are also included according to the invention. In the present invention, the term “di-rhamnolipid” is understood to mean compounds of the above formula or the salts thereof in which n is 1. Accordingly, “mono-rhamnolipid” is understood in the present invention to mean compounds of the general formula or the salts thereof in which n is 0. In certain specific embodiments, the composition comprises a mixture of mono- and di-rhamnolipids.

As used herein, “beneficiation” refers to the process by which gangue materials are removed from the product of interest (e.g., element, compound, mineral).

As used herein, “ore” refers to a naturally occurring solid material from which a valuable substance, mineral and/or metal can be profitably extracted. Ores are often mined from ore deposits, which comprise ore minerals containing the valuable substance. “Gangue” minerals are minerals that occur in the deposit but do not contain the valuable substance. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Ores, as defined herein, however, can also include ore concentrates or tailings.

As used herein, “leaching” refers to the process by which metal is extracted from ore by aqueous solutions including by, for example, ammonia leaching, alkali leaching, acid leaching, cyanidation (i.e., cyanide leaching), or thiosulfate leaching. As used herein “cyanidation” refers to the process of converting gold in ore to a water-soluble coordination complex using aqueous cyanide, including, for example, sodium cyanide, potassium cyanide, or calcium cyanide.

According to the subject invention, a harmful accumulation of material, including living organisms or non-living substances results in the process of “fouling.” “Fouling” can result in clogging, scaling, or other undesired buildup. “Fouling” can affect the efficiency, reliability, or functionality of the object.

As used herein, “scaling” refers to the process by which unwanted mineral deposits form on surfaces.

As used herein, “nucleation” refers to the formation of a nucleus (e.g., crystal) from a solution, liquid, or vapor.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Anti-Scaling Compositions

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water, chemical surfactants, antiscalants, polymers, pH modifying agents, chelating agents, or any combination thereof.

In certain embodiments, the chemical surfactant of the antiscalant composition is a detergent, wetting agent, emulsifier, foaming agent, and/or dispersant.

In certain embodiments, the antiscalants can be polyacrylic acids, including, for example, poly(acrylic acid sodium salt) and sulfonated polyacrylic acid copolymer; carboxylic acids, including, for example, phosphino carboxylic acid (PCA); polymaleic acid; organophosphates, including, for example, 1-hydroxyethylidene 1,1-diphosphonic acid (HEDP), 2-phosphonobutane-1,2,4-tricarboxylic acid (PBTC), diethylenetriamine penta (methylene phosphonic acid) (DETPMP), amino trimethylene phosphonic acid (ATMP); polyphosphates, including, for example, sodium hexametaphosphate and sodium tripolyphosphate; phosphonates, including, for example, amino tris(methylenephosphonic acid), 1-hydroxyethylidene-1,1-diphosphonic acid, and phosphonobutane-tricarboxylic acid; anionic polymers, and ethylene glycol.

In certain embodiments, the polymer can include natural or synthetic polymers, water soluble polymers, cationic polymers, anionic polymers, or non-ionic polymers. The polymers can be, for example, polyacrylic acid polymers, polymaleic acid polymers, co-polymers and multi-polymers containing various functional groups such as, for example, acrylic acid, hydroxypropyl acrylate (HPA), 2-acrylamido-2-methylpropane sulfonic acid (AMPS), ter-butyl acrylate (TBA), and sulfonated styrene (SS).

In certain embodiments, the pH modifying agents are acidifying agents or alkalizing agents. In certain embodiments, the acidifying agent includes, for example, acetic acid, citric acid, fumaric acid, hydrochloric acid, lactic acid, malic acid, nitric acid, phosphoric acid, propionic acid, sodium phosphate monobasic, sulfuric acid, tartaric acid, or any combination thereof. In certain embodiments, the alkalizing agent includes, for example, ammonia, ammonium carbonate, diethanolamine, monoethanolamine, potassium hydroxide, sodium bicarbonate, sodium borate, sodium carbonate, sodium hydroxide, sodium phosphate dibasic, trolamine, or any combination thereof.

In certain embodiments, chelating agents can be, but are not limited to, ethylenediaminetetraacetic acid (EDTA), nitrilotriacetic acid (NTA), a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na5P3O10), trisodium phosphate (TSP), water, carbohydrates, organic acids with more than one coordination group (e.g., citric acid), lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na4, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

In certain embodiments, the antiscalant composition comprises a microbe-based product comprising a biosurfactant utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. In preferred embodiments, the SLP is a linear SLP or a derivatized linear SLP. In certain embodiments, the subject compositions can comprise lactonic and linear SLP, with at least about 50%, about 55%, about 60%, about 65%, about 70%, about 75%, about 80%, about 85%, about 90%, or about 95% of the SLP comprising linear forms, and the remainder comprising lactonic forms.

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total antiscalant composition.

In another embodiment, a purified biosurfactant may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of liquid being treated.

In certain embodiments, the chemical surfactant of the antiscalant composition is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total antiscalant composition.

In some embodiments, the antiscalant, polymer, pH modifying agent, and/or chelating agent can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total antiscalant composition.

The antiscalant composition can further comprise other additives such as, for example, carriers, other microbe-based compositions, additional biosurfactants, biocides, enzymes, catalysts, solvents, salts, buffers, acids, emulsifying agents, lubricants, solubility controlling agents, preservatives, stabilizers, ultra-violet light resistant agents, viscosity modifiers, preservatives, tracking agents, and other microbes and other ingredients specific for an intended use.

In certain embodiments, the antiscalant composition can be a liquid, a solid or a semi-solid, such as, for example, a powder or a paste.

### Methods of Inhibiting Scale Formation and the Removal of Scale

In certain embodiments, the subject invention provides a method for inhibiting scale formation in, for example, a liquid solution or on surface or removing scale buildup from, for example, surfaces, particularly a surface at mining sites, quarrying sites, water treatment sites, mineral processing sites, oil and gas extracting sites, oil and gas refining sites, hydraulic fracturing sites, agricultural sites, and industrial sites.

In certain embodiments, the microbe-containing and/or biosurfactant-containing composition increases the longevity of a surface and/or object to which it is applied by preventing fouling of the surface and/or object or scale buildup by non-living substances. The subject invention can be used to prevent deposition of precipitates. Thus, the present invention allows for delaying or completely removing the necessity for preventative maintenance related to removing precipitates and deposits, as well as the need for replacing or repairing equipment parts.

The anti-scaling compositions of the subject invention can be applied to a variety of inorganic or organic objects such as, for example, steel, aluminum, copper, polyvinylchloride, polypropylene, polyvinylidene fluoride (PVDF), iron, wood, plastic, gypsum, paper, silk, glass, cotton, concrete, plaster, clay, stucco, or rubber. The compositions can be applied to objects that reside a range of temperatures, atmospheric pressures, or aquatic environments.

The composition can be applied to the surface by spraying using, for example, a spray bottle or a pressurized spraying device. The composition can also be applied using a cloth or a brush, wherein the composition is rubbed, spread or brushed onto the surface. Furthermore, the composition can be applied to the surface by dipping, dunking or submerging the surface into a container having the composition therein.

In certain embodiments, the subject invention provides a method for inhibiting scale formation or removing scale from equipment used during mining or the processing of materials, particularly tailings, resulting from mining. In preferred embodiments, the tailings are low-grade tailings, in which the tailings comprise less than about 50%, about 40%, about 35%, about 30%, or about 25% of the product of interest (e.g., metal, mineral, compound or element being mined), with the remainder comprising gangue.

In certain embodiments, the mining site can be a coal mine, iron ore mine, copper mine, copper-nickel mine, tin mine, nickel mine, gold mine, silver mine, molybdenum mine, aluminum mine (e.g., bauxite mine, kyanite mine), lead-zinc mine, tungsten mine, or zinc mine. The mine can be an underground mine, surface mine, placer mine or in situ mine.

In certain embodiments, methods of inhibiting scale formation are provided according to the subject methods by contacting the antiscalant compositions to various water streams, piping, pumps, drains, vessels, water storage areas, or other aquatic environments. The compositions can be applied to liquids that reside at a range of temperatures and aquatic environments, such as, for example, a stream, river, waterway, ocean, sea, lake, pond, runoff area, containment pond, or wastewater treatment/holding tank.

In certain embodiments, the microbe-containing and/or biosurfactant-containing composition can reduce the amount of scale that is attached or attaches to a surface, such as, for example, mineral scale on the inner surface of a liquid holding vessel.

The antiscalant composition can be applied to a liquid and, optionally, mixed by adding, pouring, or combining.

In certain embodiments, the time period in which the antiscalant composition can be contacted to a liquid or surface is for about 1 second to about 1 year, about 1 minute to about 1 year, about 1 minute to about 6 months, about 1 minute to about 1 month, about 1 minute to about 1 week, about 1 minute to about 48 hours, about 30 minutes to 40 hours, or preferably about 12 hours to 24 hours. In certain embodiments, the methods comprise applying a liquid form of the antiscalant composition to the liquid or surface for the period of time in which a liquid containing minerals is being produced or until the amount of scale has been reduced to an amount that is determined to be satisfactory, which can be readily determined by one skilled in the art. The amount of scale may be considered acceptable depending on the context. For example, the amount of scale may be acceptable in higher amounts at mining sites than in breweries.

In certain embodiments, the amount of the antiscalant composition applied is about 0.00001 to 15%, about 0.00001 to 10%, about 0.0001 to 5%, about 0.001 to 3%, about 0.01%, or about 1 vol % based on an amount of liquid that is treated.

In certain embodiments, the methods of the subject invention result in at least a 25% reduction in the amount of scale on a surface, preferably at least a 50% decrease, after one treatment. In certain embodiments, the methods of the subject invention result in at least a 25% reduction in the rate of scale formation, preferably at least a 50% decrease, after one treatment. In certain embodiments, a liquid or surface can be treated multiple times to further decrease the amount of scale or rate of scale formation.

In certain embodiments, the antiscalant composition according to the subject invention is effective due to the ability to maintain supersaturated solutions of soluble salts (i.e., threshold inhibition), altering the shape of scale crystals, and/or separating scale-forming crystals. The subject antiscalant compositions can distort crystal shapes, resulting in soft, non-adherent scale (i.e., crystal modification). For example, as a crystal begins to form, negatively charged groups of an antiscalant molecule can interact with the positively charged molecules on the mineral, interrupting the charge on the surface of the mineral required to propagate the crystal growth. This interruption of the charge on the surface of the mineral crystals causes an altered appearance of the scale. In certain embodiments, the antiscalant composition can adsorb on crystals or particles and impart a high anionic charge, which can keep the crystals separated (i.e., dispersion) from each other or a surface.

To slow and minimize scale formation, the antiscalants can modify the surfaces of existing crystals so that new layers of scale do not form. For any scale that does form, the antiscalants disrupt the structure of the scale, making it easier to remove. In some embodiments, a sophorolipid will form a micelle containing a mineral, wherein the micelle is less than 1 mm, 100 μm, 50 μm, 20 μm, 10 μm, 1 μm, 100 nm, less than 50 nm, less than 25 nm, less than 15 nm or less than 10 nm in size. The small size and amphiphilic properties of the micelle allow for enhanced dispersion of the minerals in a liquid so that a greater reduction of scale formation can occur.

In certain embodiments, the antiscalant compositions can be used in methods of processing ores, ore slurries, or other products obtained via mining. In certain embodiments, the antiscalant compositions can be used in beneficiation processes. In order to extract the element or compound of interest, it can be necessary to crush and grind the ore and preconcentrate or separate the element or product of interest from the ore by flotation, settling, filtration, or gravity separation. In certain embodiments, minerals can accumulate on filters or other surfaces during concentrating/purifying steps, and the processing efficiency can be improved by adding the antiscalant compositions during, before, or after the beneficiation process to eliminate or reduce the buildup of scale.

In certain embodiments, the antiscalant compositions can be used in methods of leaching, such as, for example, gold cyanidation. The process of extraction by leaching includes leaching (e.g., cyanide leaching), washing and filtering of leaching pulp, extraction of the metal from the leaching solution or pulp, and smelting of finished products. In certain embodiments, the antiscalant compositions can be used in methods of washing and filtering leaching pulp, in which the antiscalant compositions decrease the rate of scale formation and/or remove scale from the surface of equipment used in the washing and filtering steps.

In certain embodiments, the antiscalant composition can be used in various industrial methods, including in the manufacturing or processing of food, beverages, oil and gas, and paper. During the manufacturing of products or during methods of water purification (e.g., reverse osmosis), antiscalant compositions can be used to treat water or surfaces that contact water, in which minerals, such as, for example, calcium carbonate, calcium sulfate, calcium phosphate, aluminum silicate, zinc phosphate, iron phosphate, calcium magnesium silicate, silica, strontium sulfate, barium sulfate, calcium phosphate, calcium fluoride, and magnesium silicate, are present and can clog filters, membranes, or other surfaces. The subject methods can remove mineral scale from a surface and inhibit minerals from crystallizing on a surface.

In certain embodiments, the subject antiscalant compositions can be used in methods of produced water treatment. The water treatment comprises adding an antiscalant composition to the water that returns to the surface after the hydraulic fracturing procedure (i.e., produced water) to inhibit the formation of scale or remove scale from tubes, pipes, pumps, drains, drills, or other equipment used during hydraulic fracturing. In certain embodiments, antiscalant compositions can also be used during the production process of, for example, beer and other beverages, particularly as part of a water treatment.

In certain embodiments, the subject antiscalant compositions can be used in methods of scale removal or the inhibition of scale formation at sites in which heat exchange occurs or water containing minerals stands, such as, for example, water lines, drain lines, boilers, water heaters, chillers, heat exchanges, cooling towers, condensers, or any combination thereof. In certain embodiments, the subject compositions can be directly added to water lines, drain lines, boilers, water heaters, chiller, heat exchanges, cooling towers, condensers, or any combination thereof. The subject compositions can be allowed to stay in the water lines, drain lines, boilers, water heaters, chillers, heat exchanges, cooling towers, or condensers for a period of time to allow for removal of the scale, such as, for example, at least about 1 min, about 30 min, about 1 h, about 3 h, about 6 h, about 12 h, or about 24 hr. In certain embodiments, after the subject compositions are allowed to remain in the water lines, drain lines, boilers, water heaters, chillers, heat exchanges, cooling towers, or condensers, the scale can be removed by flushing the water lines, drain lines, boilers, water heaters, chillers, heat exchanges, cooling towers, condensers with a liquid, including for example, the subject antiscalant compositions or water. In certain embodiments, the subject compositions can be pumped or otherwise allowed to move through the water lines, drain lines, boilers, water heaters, chillers, heat exchanges, cooling towers, or condensers. In certain embodiments, the water lines, drain lines, boilers, water heaters, chillers, heat exchanges, cooling towers, or condensers can be at residential sites, including, for example single family homes, duplexes, or apartment buildings; commercial sites, including, for example, office buildings, schools, or retail stores; construction sites; or industrial sites, including, for example, power generation stations, manufacturing plants, warehouses, mines, oil and gas wells, oil and gas refineries, and ore refineries.

In certain embodiments, the buildup of scale on a surface can be determined before a surface or liquid/fluid is treated by the subject compositions. In certain embodiments, the amount of scale can be determined by a visual observation of a surface, or it can be determined by measuring the depth or thickness of the scale of a surface. In certain embodiments, the amount of scale can be determined by measuring the concentration of a mineral (e.g., calcium carbonate, calcium sulfate, halite, etc.) in a liquid, which can be performed by a sensor in a vessel containing the liquid or by removing a portion of the liquid and measuring the concentration of the mineral in the liquid. In certain embodiments, an increase in scale buildup can be determined by observing a change in the physical properties of the fluid, including, for example, an increase in pressure in a vessel that holding the liquids (i.e., as scale impedes the flow of a fluid through a vessel, the pressure is increased in the now narrower vessel), temperature, and/or pH (e.g., a higher concentration of minerals in a fluid can alter the pH of the fluid).

In certain embodiments, the subject invention can also be added to an oil well or hydraulic fracturing site to inhibit the formation of scale and/or reduce the amount of existing scale. In certain embodiments, the subject compositions can be injected about 600 feet to about 5,000 feet deep in the ground. In certain embodiments, the composition can be applied to casing sections surrounding the hydraulic fracturing site. In certain embodiments, the subject composition can be transported into a horizontally or vertically drilled hole. In certain embodiments, the composition can be added to the hydraulic fracturing site prior to when the fracturing occurs. In certain embodiments, the composition can be added to the reservoir with a fluid used in the hydraulic fracturing process. In certain embodiments, the composition can be added to the oil and/or natural gas mixtures as it is being removed from the reservoir or after the oil and/or natural gas has been extracted.

In certain embodiments, the composition of the subject invention can be applied to oil wells. The composition can be applied to the oil reservoir before oil is extracted, during the extraction process, or after the oil is extracted.

In certain embodiments, a conventional hydraulic fracturing fluid is primarily composed of a base fluid (e.g., at least about 85%, about 86%, about 87%, about 88%, about 89%, about 90%, about 91%, about 92%, about 93%, about 94%, about 95%, about 96%, about 97%, about 98%, about 99%, about 99.5%), such as, for example, water; a proppant, such as, for example, quartz sand and or silica; and additional additives, such as, for example, an acid, biocide, breaker, corrosion inhibitor, crosslinker, friction reducer, gel, iron controller, potassium chloride, oxygen scavenger, pH adjusting agent, scale inhibitor (e.g., ethylene glycol), surfactant (e.g., isopropanol), or any combination thereof.

In certain embodiments, the subject methods can also inhibit scale formation at a variety of pressures, including high pressures of at least about 4,500 psi, about 5,000 psi, about 6,000 psi, about 7,000 psi, about 8,000 psi, about 9,000 psi, about 10,000 psi, about 11,000 psi, about 12,000 psi, about 13,000 psi, about 14,000 psi, or about 15,000 psi. In certain embodiments, the high pressures exist at sites of hydraulic fracturing. In certain embodiments, the composition can be applied to a site at high temperatures, such as, for example, at least about 200° F., about 250° F., about 300° F., about 350° F., or about 400° F.

In certain embodiments, the subject compositions can be applied to pipelines and downhole tubulars in oil drilling and hydraulic fracturing operations. In certain embodiments, the scale can be asphaltenes, paraffin, waxes, resins, or any combination thereof.

In certain embodiments, the subject compositions and methods can also be used in the oil recovery and refinement processes and in natural-gas processing plants to inhibit the formation of scale and/or reduce the amount of existing scale. In certain embodiments, the composition can be applied to surfaces of heat exchangers in an oil refinery plant. In certain embodiments, the composition can be applied to the surface of pipes that scale has formed on in an oil refinery plant. In certain embodiments, the composition can be applied to surfaces of separators, treaters, free water knock outs, indirect line heaters, gas production units, gas dehydration units, glycol contact towers, vapor recovery towers, oil stabilizing towers, pressure vessels, fired heaters, piping systems, heat exchangers, storage tanks, pumps, compressors, and any other equipment in an oil refinery and/or natural-gas processing plants.

Advantageously, in certain embodiments, the antiscalant composition according to the subject invention provides enhanced or increased efficiency of inhibiting scale formation or removing scale from a surface with limited negative environmental impacts. Additionally, the methods of the subject invention do not require complicated equipment or high energy consumption, and the production of the antiscalant composition can be performed on site, including, for example, at a mine or at an industrial site. In certain embodiments, the subject antiscalant composition can result in a decreased use of synthetic antiscalants, or other potentially harmful chemicals used for inhibiting scale formation or removing scale.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

1. A method of inhibiting scale or removing scale, the method comprising contacting an antiscalant composition comprising a biosurfactant with a liquid containing a mineral, a surface that contacts the liquid containing a mineral, and/or a surface fouled with mineral scale.

2. The method of claim 1, further comprising measuring an amount of scale on the surface that contacts the liquid containing a mineral, the surface fouled with mineral scale, or in the liquid containing a mineral before the antiscalant composition is applied to the liquid containing a mineral, to the surface that contacts the liquid containing a mineral, or to the surface fouled with mineral scale.

3. The method of claim 2, wherein measuring the amount of scale comprises measuring the depth or thickness of the scale, measuring the concentration of a mineral, measuring the pressure in a vessel that holds the liquid containing a mineral, and/or measuring the temperature and/or pH of the liquid containing a mineral.

4. The method of claim 1, wherein the liquid is groundwater, municipal wastewater, stormwater, mining wastewater, quarrying wastewater, produced water, industrial wastewater or a slurry of ore.

5. (canceled)

6. The method of claim 4, wherein the slurry of ore is from a coal mine, iron ore mine, copper mine, copper-nickel mine, tin mine, nickel mine, gold mine, silver mine, molybdenum mine, aluminum mine, lead-zinc mine, tungsten mine, or zinc mine.

7. The method of claim 1, wherein the surface that contacts the liquid containing a mineral or the surface fouled with mineral scale comprises steel, aluminum, copper, polyvinylchloride, polypropylene, polyvinylidene fluoride (PVDF), iron, wood, plastic, gypsum, paper, silk, glass, cotton, concrete, plaster, clay, stucco, or rubber.

8. The method of claim 1, wherein the antiscalant composition further comprises a chemical surfactant, polymer, pH modifying agent, or chelating agent.

9-10. (canceled)

11. The method of claim 1, wherein applying the antiscalant composition to the surface that contacts the liquid containing a mineral or the surface fouled with mineral scale comprises spraying, rubbing, spreading or brushing the antiscalant composition onto the surface or dipping, dunking or submerging the surface that contacts the liquid containing a mineral or the surface fouled with mineral scale in the antiscalant composition.

12. The method of claim 1, wherein the biosurfactant is a sophorolipid.

13. The method of claim 1, wherein the antiscalant composition comprises a Starmerella sp. and/or a Candida sp. yeast.

14. The method of claim 13, wherein the yeast is inactive.

15-17. (canceled)

18. An antiscalant composition comprising a sophorolipid and/or a yeast culture comprising a sophorolipid and one or more traditional antiscalant components;
wherein the yeast culture is a Starmerella sp. and/or a Candida sp. yeast; and
wherein the traditional antiscalant components are selected from:
a) chemical surfactants;
b) polymers;
c) pH adjusting agents;
d) chelating agents; and
e) ethylene glycol.

19-23. (canceled)

24. A method of inhibiting scale or removing scale, the method comprising contacting an antiscalant composition comprising a biosurfactant with a hydraulic fracturing fluid, an oil well, or a surface fouled with mineral scale.

25. The method of claim 24, further comprising measuring an amount of scale on the surface that contacts the hydraulic fracturing fluid, the surface fouled with mineral scale, or in the oil well before the antiscalant composition is applied to the hydraulic fracturing fluid, to the oil well, or to the surface fouled with mineral scale.

26. The method of claim 25, wherein the measuring the amount of scale comprises measuring the depth or thickness of the scale, measuring the concentration of minerals, measuring the pressure in a vessel, oil well, or hydraulic fracturing, or measuring the temperature and/or pH of the hydraulic fracturing fluid.

27-29. (canceled)

30. The method of claim 24, wherein the antiscalant composition further comprises at least one of a chemical surfactant, a polymer, a pH modifying agent, ethylene glycol, and a chelating agent.

31-32. (canceled)

33. The method of claim 24, wherein the biosurfactant is a glycolipid.

34. The method of claim 33, wherein the antiscalant composition comprises a Starmerella sp. and/or a Candida sp. yeast.

35. The method of claim 33, wherein the composition comprises a glycolipid selected from sophorolipids, mannosylerythritol lipids, trehalose lipids, and rhamnolipids.

36-38. (canceled)
